(19) United States
(12) Patent Application Publication
(10) Pub. No.: US 2025/0372113 A1
(43) Pub. Date: Dec. 4, 2025

(54) AUDIO PROCESSING METHOD AND COMPUTER READABLE STORAGE MEDIUM

(71) Applicant: XG TECH PTE. LTD., Singapore (SG)

(72) Inventor: Yuxiang HU, Singapore (SG)

(21) Appl. No.: 19/192,021

(22) Filed: Apr. 28, 2025

(30) Foreign Application Priority Data
May 31, 2024 (CN) 202410702965.9

(51) Int. Cl. G10L 21/0272; G10L 25/30; G10L 25/78

(52) U.S. Cl. CPC G10L 21/0272; G10L 25/30; G10L 25/78

(57) ABSTRACT

Embodiments of this disclosure disclose an audio processing method and a computer readable storage medium. The method includes: acquiring a plurality of first audio signals in a space of a mobile terminal; determining, based on the plurality of first audio signals, a second audio signal corresponding to at least one position in the space of the mobile terminal; and performing audio mixing based on the at least one second audio signal to obtain a third audio signal.

### CROSS-REFERENCE TO RELATED APPLICATION

The present disclosure claims priority to Chinese Patent Application No. 202410702965.9 filed on May 31, 2024, which is incorporated herein by reference in its entirety.

### TECHNICAL FIELD

The present disclosure relates to the technical field of voice processing, and in particular, to an audio processing method and apparatus, a computer readable storage medium, and an electronic device.

### BACKGROUND

In-vehicle karaoke television (KTV) is an entertainment function provided in a vehicle, allowing a passenger to enjoy singing in the vehicle. Such a function is typically realized by installing particular software and devices in an intelligent system of the vehicle, allowing the passenger to sing using a built-in microphone (MIC) or using a MIC connected to a mobile phone. The appeal of the in-vehicle KTV lies in its ability to provide the passenger with an experience rivaling a professional KTV booth, allowing the passenger to enjoy singing whether in the vehicle on a daily basis or while traveling. Karaoke by using a MIC built in the vehicle is referred to as in-vehicle MIC-free karaoke for short, where karaoke experience needs to be improved when a multi-singer karaoke mode is started for in-vehicle MIC-free karaoke.

### SUMMARY

To resolve the foregoing technical problem, the present disclosure provides an audio processing method and apparatus, a computer readable storage medium and an electronic device.

According to one aspect of embodiments of the present disclosure, an audio processing method is provided, including: acquiring a plurality of first audio signals in a space of a mobile terminal; determining, based on the plurality of first audio signals, a second audio signal corresponding to at least one position in the space of the mobile terminal; and performing audio mixing based on at least one second audio signal to obtain a third audio signal.

According to another aspect of the embodiments of the present disclosure, an audio processing apparatus is provided, including: an audio acquisition module, configured to acquire a plurality of first audio signals in a space of a mobile terminal; an audio screening module, configured to determine, based on the plurality of first audio signals, a second audio signal corresponding to at least one position in the space of the mobile terminal; and a signal processing module, configured to perform audio mixing based on the at least one second audio signal to obtain a third audio signal.

According to still another aspect of the embodiments of the present disclosure, a computer readable storage medium is provided, on which a computer program is stored, where the computer program, when executed by a processor, causes the processor to implement the audio processing method according to any one of the foregoing embodiments.

According to yet another aspect of the embodiments of the present disclosure, an electronic device is provided, including: a processor; and a memory, configured to store instructions executable by the processor, where the processor is configured to read the executable instructions from the memory and execute the instructions to implement the audio processing method according to any one of the foregoing embodiments.

Based on the audio processing method and apparatus, the computer readable storage medium, and the electronic device that are provided in the foregoing embodiments of the present disclosure, a second audio signal corresponding to at least one position in a space of a mobile terminal is determined from a plurality of first audio signals, achieving recognition of a second audio signal corresponding to at least one position at which a voice is emitted. Audio mixing is performed only on at least one second audio signal to obtain a third audio signal, and a signal corresponding to a position at which no voice is emitted does not participate in the audio mixing, thereby improving sound quality of the third audio signal.

The technical solutions of the present disclosure are further described in detail below through accompanying drawings and embodiments.

### BRIEF DESCRIPTION OF DRAWINGS

The foregoing and other objectives, features, and advantages of the present disclosure will become more apparent from the more detailed description of the embodiments of the present disclosure with reference to the accompanying drawings. The accompanying drawings, constituting a part of this specification, are used for a further understanding of the embodiments of the present disclosure are used together with the embodiments of the present disclosure to explain the present disclosure, and are not construed as limiting the present disclosure. In the accompanying drawings, same reference signs typically indicate same components or steps.

FIG. 1 is a schematic flowchart illustrating an audio processing method according to an exemplary embodiment of the present disclosure;

FIG. 2 is a schematic flowchart illustrating determining of a second audio signal in an audio processing method according to an exemplary embodiment of the present disclosure;

FIG. 3 is a schematic flowchart illustrating determining of a second audio signal in an audio processing method according to another exemplary embodiment of the present disclosure;

FIG. 4 is a schematic flowchart illustrating determining of a third audio signal in an audio processing method according to an exemplary embodiment of the present disclosure;

FIG. 5 is a schematic flowchart illustrating determining of a third audio signal in an audio processing method according to another exemplary embodiment of the present disclosure;

FIG. 6 is a schematic diagram illustrating a structure of an audio processing apparatus according to an exemplary embodiment of the present disclosure;

FIG. 7 is a schematic diagram illustrating a structure of an audio processing apparatus according to another exemplary embodiment of the present disclosure;

FIG. 8 is a schematic diagram illustrating a structure of an audio processing apparatus according to still another exemplary embodiment of the present disclosure;

FIG. 9 is a schematic diagram illustrating a structure of an audio processing apparatus according to yet another exemplary embodiment of the present disclosure;

FIG. 10 is a schematic diagram illustrating a structure of an audio processing apparatus according to still yet another exemplary embodiment of the present disclosure; and

FIG. 11 is a diagram illustrating a structure of an electronic device according to an exemplary embodiment of the present disclosure.

### DETAILED DESCRIPTION OF THE EMBODIMENTS

To explain the present disclosure, exemplary embodiments of the present disclosure will be described in detail below with reference to the accompanying drawings. Apparently, the described embodiments are merely some of embodiments of the present disclosure, rather than all of the embodiments of the present disclosure. It should be understood that, the present disclosure is not limited by the exemplary embodiments.

It should be noted that, unless otherwise specified, the scope of the present disclosure is not limited by relative arrangement, numeric expressions, and numerical values of components and steps described in these embodiments.

### Application Overview

In a process of implementing the present disclosure, the inventor has found that, in a conventional MIC-free karaoke solution, audio mixing is performed on all sound signals which are acquired. If there is nobody at a certain position, or a user at a certain position does not emit a voice, a sound signal corresponding to the position has a relatively low signal-to-noise ratio. If the sound signal with the relatively low signal-to-noise ratio participates in the audio mixing, sound quality of an output audio signal may be reduced. According to an audio processing method provided in the present disclosure, the sound signal having the low signal-to-noise ratio can be recognized and removed, thereby improving experience of MIC-free karaoke.

### Exemplary Method

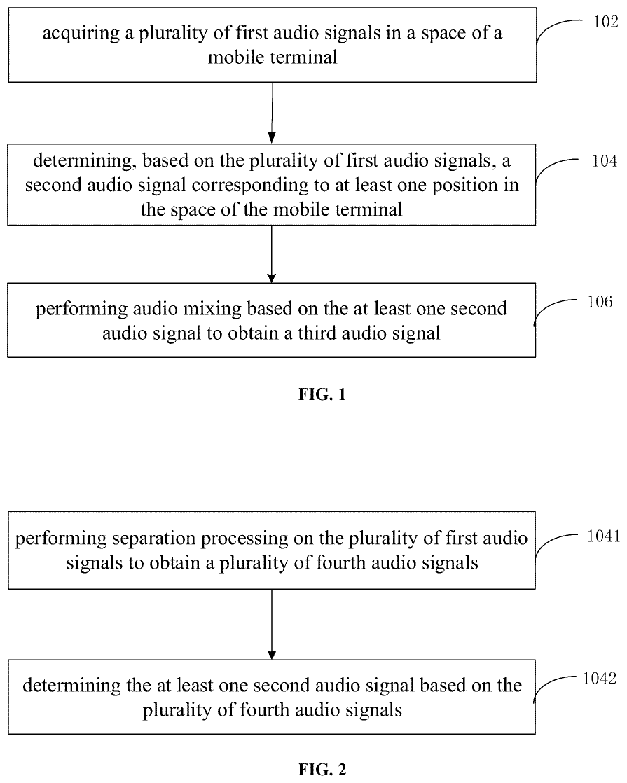

FIG. 1 is a schematic flowchart illustrating an audio processing method according to an exemplary embodiment of the present disclosure. This embodiment may be applied to an electronic device, and as shown in FIG. 1, includes the following steps:

Step 102: Acquiring a plurality of first audio signals in a space of a mobile terminal.

The mobile terminal may be a manned mobile device such as a vehicle, a flight device (for example, an airplane or an aircraft), or a ship. The plurality of first audio signals may correspond to a plurality of positions in the space of the mobile terminal. Optionally, each of the positions corresponds to one first audio signal. The position in this embodiment of the present disclosure may also be expressed as a sound zone, for example, an area in the space of the mobile terminal where a target sound signal (a vocal signal) may exist. The first audio signal may be a sound signal acquired through a sound pickup device such as a MIC or a MIC array built in the mobile terminal. The first audio signal may include a voice signal (which may also be referred to as a vocal signal) or may not include a voice signal.

Step 104: Determining, based on the plurality of first audio signals, a second audio signal corresponding to at least one position in the space of the mobile terminal.

In one embodiment, each position in the space of the mobile terminal may be construed as a sound zone. Optionally, in some optional examples, according to this embodiment, the plurality of first audio signals are separated to obtain sound signals respectively corresponding to each of the positions. Then, voice signal detection is processed on the sound signals to determine whether each sound signal includes human voice, to implement screening of the first audio signals. A first audio signal including human voice is used as a second audio signal, thus obtaining at least one second audio signal. In some other optional examples, user feature information with a wide variety of information may be acquired in combination with other information acquisition devices built in the mobile terminal other than an audio acquisition device. Visual recognition is implemented in combination with the user feature information (including, for example, image information or video information) to determine whether a position corresponding to the user feature information is a voice emission position. For example, whether lip movement is detected from a user at a corresponding position/in a corresponding sound zone through the image information or the video information. If lip movement is detected, it is roughly considered that the user at the position/in the sound zone is singing karaoke. In this case, only a first audio signal corresponding to the position/the sound zone where voice is present is determined as a second audio signal, thus obtaining at least one second audio signal. For example, the visual recognition in this embodiment may be to perform recognition on the image information or the video information through a preset recognition network model and determine whether the position corresponding to the user feature information is a voice emission position; or to perform recognition on the image information or the video information through a lip movement recognition network model to determine whether there is lip movement in the image information or the video information, and through comparing a lip movement result (for example, lip movement amplitude and/or a lip movement frequency) with preset lip movement information (for example, preset lip movement amplitude and/or preset lip movement frequency) to determine the position corresponding to the user feature information as a voice emission position when the lip movement result complies with the preset lip movement information. Further, a first audio signal corresponding to the voice emission position may be determined as a corresponding second audio signal.

Step 106: Performing audio mixing based on the at least one second audio signal to obtain a third audio signal.

Optionally, the audio mixing may be to perform mixing processing on the at least one second audio signal to obtain a third audio signal.

According to the audio processing method provided in the foregoing embodiment of the present disclosure, a second audio signal corresponding to at least one position in a space of a mobile terminal is determined from a plurality of first audio signals, achieving recognition of the second audio signal corresponding to at least one position at which a voice is emitted. Audio mixing is performed only on at least one second audio signal to obtain a third audio signal, and a signal corresponding to a position at which no voice is emitted does not participate in the audio mixing, thereby improving sound quality of the third audio signal. Through sound recognition at each position/in each sound zone in the present disclosure, karaoke statuses at different positions (that is, whether there are users, singing karaoke, at different positions) are determined. Then, subsequent processing is further performed on an audio signal from a position/a sound zone actually participating in karaoke, thereby improving a karaoke effect and experience of a user.

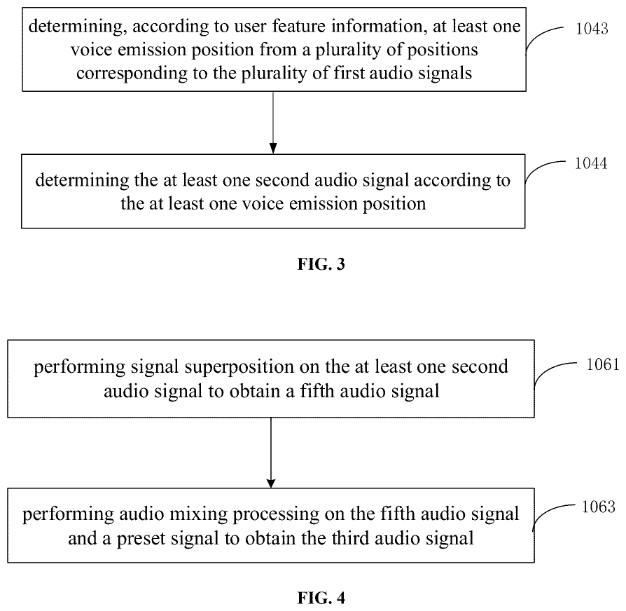

As shown in FIG. 2, in some optional embodiments, based on the foregoing embodiment shown in FIG. 1, step 104 may include the following steps:

Step 1041: Performing separation processing on the plurality of first audio signals to obtain a plurality of fourth audio signals.

Optionally, the plurality of first audio signals may be separated into a plurality of fourth audio signals corresponding to a plurality of positions by a sound separation technology. Optionally, the sound separation technology may include, but is not limited to: a spectral subtraction method, a sound source localization method, an artificial intelligence sound separation method, and the like. The spectral subtraction method is a sound separation method based on frequency domain analysis by calculating a frequency domain difference between a mixed signal and an original signal and applying the difference to a spectrum of the mixed signal to achieve sound separation. The sound source localization method is a method of determining a sound source position by analyzing information such as an arrival time difference, an amplitude difference, and a phase difference of sound in different sound pickup devices. The artificial intelligence sound separation method is a sound separation algorithm utilizing machine learning and a deep neural network. For example, the first audio signals are mixed with different human voice and noise. Different first audio signals are picked up by MICs or MIC arrays at different positions/in different sound zones. For example, when the mobile terminal has four sound zones, four first audio signals may be picked up. The fourth audio signals include separate or relatively pure vocal signals, or also include noise. For example, one of the fourth audio signals may include a vocal signal of a driver user. Optionally, this fourth audio signal may also include noise inside and/or outside the mobile terminal.

Step 1042: Determining the at least one second audio signal based on the plurality of fourth audio signals.

In this embodiment, each fourth audio signal obtained through sound separation processing corresponds to one position. Optionally, voice signal detection is performed on the plurality of fourth audio signals to determine, from the plurality of fourth audio signals, at least one second audio signal that includes a voice signal (for example, a vocal signal). Optionally, a process of determining the at least one second audio signal may include: performing voice activity detection (VAD) on the plurality of fourth audio signals respectively to determine the at least one second audio signal.

VAD, also referred to as speech activity detection or speech detection, is a technology used in voice processing to detect whether a voice signal is present. Optionally, VAD is performed on each of the fourth audio signals to determine whether each of the fourth audio signals includes a voice signal. A fourth audio signal whose detection result indicates presence of a voice signal is determined as a second audio signal, to obtain at least one second audio signal.

In this embodiment, sound separation is first performed on the plurality of first audio signals so that each obtained fourth audio signal corresponds to one sound zone in the mobile terminal. Then, VAD is performed on the fourth audio signals to determine a fourth audio signal including a voice signal (a vocal signal) as a second audio signal. During audio mixing, audio mixing processing is only performed on the second audio signal including the voice signal, thereby improving sound quality of a third audio signal after the audio mixing. In a karaoke scene, audio mixing processing is only performed on a second audio signal including a vocal signal, thereby improving sound quality of the vocal signal in the karaoke scene.

In some optional embodiments, the signal separation in step 1041 may include: inputting the plurality of first audio signals into a first neural network model, and outputting the plurality of fourth audio signals respectively through a plurality of output channels of the first neural network model, where the first neural network model may be trained in advance.

For example, a number of the fourth audio signals may be a number of sound zones (positions) in the mobile terminal. For example, when the mobile terminal is a vehicle, the vehicle has four sound zones, including a driver sound zone, a front passenger sound zone, a rear left sound zone, and a rear right sound zone. Correspondingly, four fourth audio signals may be obtained after separation processing. In this embodiment of this application, the number of sound zones may be equal to a number of MIC arrays in the vehicle. For example, each of the foregoing sound zones is provided with one MIC array. Alternatively, the number of sound zones in this embodiment of this application may not be equal to a number of MIC arrays in the vehicle. For example, some sound zones are provided with multiple MIC arrays, while the other sound zones are provided with no MIC array. For example, the driver sound zone and the front passage sound zone are each provided with one MIC array, and the rear left sound zone and the rear right sound zone together are provided with one MIC array. In this case, it may be considered that the number of sound zones is not equal to the number of MIC arrays. The MIC array includes at least one MIC.

In this embodiment, the first audio signal may be a time domain signal or a frequency domain signal. The plurality of first audio signals may be directly input into the first neural network model to obtain a plurality of second audio signals directly through the first neural network model. The first audio signals may also be processed, and then the plurality of processed first audio signals may be input into the first neural network model. For example, a short-time Fourier transform may be performed on the first audio signals to obtain amplitude spectrums and phase spectrums of the first audio signals. The amplitude spectrums of the plurality of first audio signals are input into the first neural network model to obtain vocal amplitude spectrums and other amplitude spectrums of the plurality of first audio signals. An inverse short-time Fourier transform is performed on the vocal amplitude spectrums, other amplitude spectrums, and the phase spectrums of the plurality of first audio signals to obtain a plurality of separated fourth audio signals (for example, vocal signal data or other signal data). In addition, in this embodiment, a network structure of the first neural network model is not limited. Optionally, before the separation processing is performed by using the first neural network model, the first neural network model is trained by using signals with known separation results as sample audio signals. Optionally, for different types and models of mobile terminals, different sample audio signals may be used for the training to adapt to the corresponding types and models of mobile terminals, thereby improving accuracy of the first neural network model for signal separation. For example, the types of mobile terminals may include: vehicles, flight devices, ships, and the like. When the mobile terminal is a vehicle, models of the mobile terminal may include: sedans, sports cars, pickup trucks, SUVs, and the like.

As shown in FIG. 3, in some other optional embodiments, based on the foregoing embodiment shown in FIG. 1, the plurality of first audio signals correspond to a plurality of positions in the space of the mobile terminal. Step 104 may include the following steps:

Step 1043: Determining, according to user feature information, at least one voice emission position from the plurality of positions corresponding to the plurality of first audio signals.

In this embodiment, the user feature information may be acquired by acquiring user information through a device built in the mobile terminal and processing the user information. For example, a user image or a user video is captured by a camera built in the vehicle. Whether a user emits a voice is determined by performing image recognition on the user image or the user video. In this way, at least one voice emission position is determined based on a position corresponding to a user that emits a voice. Optionally, image or video recognition may be implemented through a deep neural network. For example, the image information or the video information is recognized through a preset recognition network model, to directly output a recognition result indicating whether a position corresponding to a user is a voice emission position. For another example, lip movement information in the image information or the video information is recognized through a deep neural network, and based on a lip movement recognition result to determine whether a position corresponding to a user is a voice emission position.

Step 1044: Determining the at least one second audio signal according to the at least one voice emission position.

In this embodiment, each of the plurality of acquired first audio signals corresponds to one position. After the voice emission position is determined, a first audio signal corresponding to the voice emission position may be directly determined as a second audio signal. In this way, a second audio signal including a voice signal (a vocal signal) is determined from the plurality of first audio signals. In this embodiment, recognition of a second audio signal by a simple structure is implemented in combination with the user feature information, and the recognition speed of the second audio signal is accelerated.

In some optional embodiments, the user feature information includes multimodal information of a user. Step 1043 may include: performing recognition on the plurality of positions according to the multimodal information to obtain an recognition result.

Optionally, the multimodal information includes visual information such as image information or video information.

In this embodiment, lip movement recognition may be performed on the image information or video information through a preset neural network model (for example, a recognition network model). For example, whether an image or a video includes a human face is determined firstly. If a human face is included, the lip movement recognition is performed on the human face to obtain a recognition result. In an optional example, lip shape changes in a plurality of consecutive frames in the video information are recognized to determine whether the recognition result indicates lip movement. For example, when a plurality of consecutive video frames include at least one frame in which a lip shape is an open mouth, it may be determined that the recognition result indicates that someone is emitting a voice. For another example, voice emission recognition is performed on the image information through the preset neural network model, and a recognition result indicating whether the user corresponding to the user feature information emits a voice is directly output. Optionally, recognition may be performed on the plurality of positions respectively through a plurality of preset neural network models. For example, one preset neural network model corresponds to one position. Alternatively, recognition is performed sequentially on the plurality of positions based on one preset neural network.

The at least one voice emission position is determined, according to the recognition result, from the plurality of positions corresponding to the plurality of first audio signals.

Optionally, a position where the recognition result indicates voice emission is determined as a voice emission position, thus obtaining the at least one voice emission position. In this embodiment, voice emission recognition is performed based on the image information or the video information to determine whether there is a user at a corresponding position and whether the user at the corresponding position emits a voice, thus to determine the voice emission position. In this embodiment, the voice emission position is determined through visual information, thereby accelerating the recognition speed of the voice emission position. In addition, in this embodiment, the multimodal information may be acquired through a sensor (for example, a camera) built in the mobile terminal without a new hardware device being added. Exemplarily, the voice emission position may alternatively be determined by fusing visual information and audio information (for example, carried in an audio signal), that is, by using the multimodal information of the user. Optionally, the multimodal information of the user may further include at least voice information and pressure sensor information. For example, if a person is detected by a pressure sensor in the mobile terminal, and corresponding human voice is recognized in a corresponding sound zone corresponding to the position where the person is detected by the pressure sensor, the voice emission position may also be determined. Alternatively, the multimodal information of the user may further include at least voice information and infrared sensor information. For example, if it is detected by an infrared sensor in the mobile terminal that there is a person in a driver's seat, and corresponding human voice is recognized in a corresponding sound zone corresponding to the position where the person is detected by the infrared sensor, the voice emission position may also be determined. Alternatively, the multimodal information of the user may further include at least voice information and radar (millimeter wave radar/ultrasonic radar) sensor information. For example, if it is detected by a radar sensor in the mobile terminal that there is a person in a driver's seat, and corresponding human voice is recognized in a corresponding sound zone corresponding to the position where the person is detected by the radar sensor, the voice emission position may also be determined. The above user multimodal information may be combined in any manner as long as the combination is beneficial to the recognition of the voice emission or karaoke status in this embodiment of the present disclosure.

As shown in FIG. 4, based on the foregoing embodiment shown in FIG. 1, step 106 may include the following steps:

Step 1061: Performing signal superposition on the at least one second audio signal to obtain a fifth audio signal.

Optionally, when the second audio signal is a time domain signal, a plurality of second audio signals are combined in chronological order, that is, the plurality of second audio signals are superimposed, to obtain a fifth audio signal.

In this embodiment, the fifth audio signal may be a single-channel or a multi-channel signal. The number of the channels is irrelevant to the number of the audio signals (for example, the second audio signal in this embodiment). A plurality of audio signals indicate a plurality of different audio signals. A channel refers to a passage for transmitting an audio signal (for example, the fifth audio signal in this embodiment), where an output position and amplitude of the audio signal in a loudspeaker are controlled. For example, a multi-channel surround sound system includes different channels such as a front center channel, a subwoofer channel, a front left channel, a front right channel, a rear left channel, and a rear right channel. In this embodiment, the fifth audio signal is typically a single-channel signal. When it is a multi-channel signal, the number of channels is determined according to a number of channels reserved for a DSP power amplifier. In addition, the signal superposition method may be preset according to the DSP power amplifier. The DSP power amplifier refers to a power amplifier that uses a DSP chip to optimize and manage audio parameters through a digital signal processing algorithm. It is a technology that coverts a two-channel stereo signal into a multi-channel surround sound signal. In addition to functions of other power amplifiers, the DSP power amplifier may also attenuate overlapping frequencies caused by an environment in the vehicle, and compensate for a frequency attenuated by the environment, and may also adjust a distance between each loudspeaker in the vehicle and a human ear, and the like. The DSP power amplifier may make adjustment for defects that physical adjustment cannot address.

When the second audio signal is determined based on the method provided in the embodiment shown in FIG. 3, after the fifth audio signal is obtained, an interference signal in the fifth audio signal may be eliminated, where after interference signal elimination processing is performed on the fifth audio signal based on a reference (REF) signal, proceeding to the following steps, wherein the REF signal is determined based on the third audio signal.

Step 1063: Performing audio mixing processing on the fifth audio signal and a preset signal to obtain the third audio signal.

Optionally, when the foregoing embodiment is applied to a karaoke scene, the preset signal may be a preset accompaniment signal, and the third audio signal may be a karaoke sound signal obtained by mixing a vocal signal with the preset accompaniment signal. Audio mixing is a step in audio production, which combines sounds from various sources into a stereo audio track or a mono audio track. In this embodiment, sound sources are the fifth audio signal and the preset signal, for example, a human voice audio signal and a preset accompaniment signal. In this embodiment, after the third audio signal is obtained, the third audio signal is played through a loudspeaker provided in the mobile terminal. For example, when the mobile terminal is a vehicle, a loudspeaker provided in the vehicle plays the third audio signal.

In some embodiments, to provide personalized audio effect processing for different users to satisfy audio effect requirements of the different users, before signal superposition is performed on the at least one second audio signal, audio effect processing may be performed on each second audio signal, and the second audio signals on which audio effect processing has been performed are superimposed to obtain a fifth audio signal.

An audio effect refers to an effect created for sound, and may be a noise or sound added to audio to enhance realism, atmosphere, or a dramatic message of a scene. The sound therein may include a musical sound and an effect sound. For example, for a digital audio effect, an environmental audio effect, or the like, the environmental audio effect is commonly used in audio in a KTV scene. Audio effect types in this embodiment may include, but not limited to: an equalization audio effect, an artificial reverberation audio effect, a pitch-shift audio effect, a vocal enhancement audio effect, a style-shift audio effect, and the like.

Optionally, each second audio signal corresponds to at least one audio effect type, and/or one audio effect type corresponds to at least one second audio signal. Optionally, the personalized audio effect processing provided in this embodiment may be implemented alone or in combination with step 102 and/or step 104 described above.

In some optional embodiments, the audio effect type may be determined according to an instruction input externally (for example, input by a user that emits human voice in the mobile terminal). Optionally, audio effect types corresponding to a plurality of second audio signals are determined according to a first audio effect instruction.

In this embodiment, at least one first audio effect instruction may be received simultaneously. Optionally, a plurality of first audio effect instructions correspond to a plurality of audio effect types (each first audio effect instruction corresponds to one audio effect type), or one first audio effect instruction corresponds to a plurality of audio effect types. For example, one first audio effect instruction is received to determine one vocal enhancement audio effect. For another example, one first audio effect instruction is received to determine at least a pitch-shift audio effect, an equalization audio effect, and the like. By determining an audio effect type according to an audio effect instruction, it is achieved to determine a corresponding audio effect type according to active selection of a user, so that user engagement is enhanced and a second audio signal that better satisfies a user requirement may be obtained. Alternatively, audio effect types for a plurality of users may be determined by receiving one first audio effect instruction, so that user operations can be further simplified, where one user's instruction can implement audio effect processing for different users.

The first audio effect instruction described in this disclosure may be a user's speech instruction, visual instruction, gesture instruction, or operational instruction. This application imposes no limitations on the type of the first audio effect instruction.

In other optional embodiments, the audio effect type may be automatically determined based on user-related information. Optionally, the audio effect type corresponding to the plurality of second audio signals is determined based on user-related information.

In this embodiment, user-related information may be obtained by processing user information acquired via built-in devices of the mobile terminal. For example, user images captured via built-in cameras are analyzed through image recognition to determine user-related information such as age and gender. Optionally, user-related information may also be obtained through user input. Optionally, a plurality of audio effect types may be determined based on a plurality of sets of user-related information (each audio effect type being determined based on one set of user-related information), or the plurality of audio effect types may be determined based on one set of user-related information. A correspondence between different user-related information and different audio effect types may be pre-stored in the mobile terminal. As an example, the correspondence may be in a form of a table and stored in the mobile terminal, so that the determination of the audio effect type may be achieved via table lookup. For example, at least one audio effect type corresponding to each of the plurality of sets of user-related information in the preset table may be statistically determined from big data, wherein each set of user-related information contains at least one type of user-related datum. According to this embodiment, automatic matching of the audio effect type can be achieved based on user-related information, the efficiency of determining the audio effect type being improved.

Optionally, the user-related information may include information extracted and fused from data of various modalities (that is, various types or sources). Such information not only includes multimedia data such as text, an image, audio, and a video, but also involves comprehensive processing and fusion on such data. In this embodiment, the multimodal information of the user may include, but is not limited to an image, audio, a video and other multimedia data of the user. The gender, age, or other information of the user may be obtained by processing the multimodal information (processing image, audio, video, or the like of the user through a deep neural network model).

In an optional example, audio effect types corresponding to a plurality of second audio signals are acquired from audio effect library according to the multimodal information.

A plurality of audio effect types are prestored in the audio effect library. Optionally, in the audio effect library, in addition to the plurality of prestored audio effect types, an audio effect processing method corresponding to each of the audio effect types are also stored. In this embodiment, after the multimodal information of the user is determined, user-related information may be determined according to the multimodal information, and a corresponding audio effect type is automatically selected for the user. For example, it is determined, according to multimodal information of a user, that user-related information includes gender of female and age about 20 years old, a corresponding pitch-shift audio effect and style-shift audio effect may be determined through lookup of the table. That is, in this embodiment, automatic matching of an audio effect type and a second audio signal can be implemented through multimodal information, thereby improving efficiency of determining the audio effect type.

After an audio effect type corresponding to each second audio signal is determined, corresponding audio effect processing is performed on the plurality of second audio signals based on the audio effect types to correspondingly obtain a plurality of second audio signals on which the audio effect processing has been performed.

Optionally, different audio effect types correspond to different audio effect processing methods. Optionally, one audio effect type corresponds to one audio effect processing method. For example, an equalization audio effect corresponds to an audio equalization method, or a pitch-shift audio effect corresponds to an audio pitch-shift method. After the audio effect types are determined, the audio effect processing of the second audio signals is implemented through an audio effect processing method. In this embodiment, a corresponding audio effect type is determined for the second audio signal, and the second audio signal is processed based on an audio effect processing method of the corresponding audio effect type to obtain a second audio signal with a corresponding audio effect.

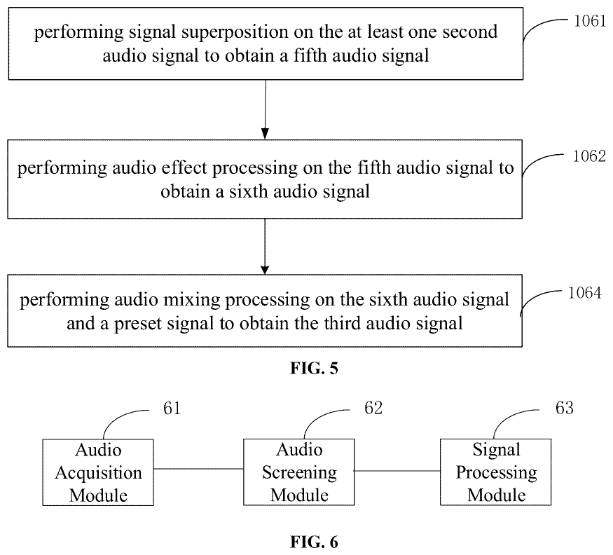

As shown in FIG. 5, based on the foregoing embodiment shown in FIG. 1, step 106 may include the following steps:

Step 1061: Performing signal superposition on the at least one second audio signal to obtain a fifth audio signal.

Step 1062: Performing audio effect processing on the fifth audio signal to obtain a sixth audio signal.

In addition to performing audio effect processing before performing signal superposition on the second audio signal according to the foregoing embodiment, according to this embodiment, audio effect processing on the fifth audio signal is further performed after performing signal superposition on the second audio signal. The process of audio effect processing may include: determining an audio effect type for the fifth audio signal, and performing processing on the fifth audio signal according to an audio effect processing method corresponding to the audio effect type. In this embodiment, for the method for determining an audio effect type, reference may be made to the process of determining the audio effect type for the second audio signal in the foregoing embodiment, except that one or at least one audio effect type may be selected from the determined at least one audio effect type to implement the audio effect processing for the fifth audio signal. Optionally, when determining an audio effect type based on user-related information while a plurality of users are included in the space of the mobile terminal, a plurality of audio effect types may be determined respectively according to a plurality of pieces of user-related information. In this case, some or all of the audio effect types may be selected for performing the audio effect processing on the fifth audio signal. For example, three audio effect types (a pitch-shift audio effect, a vocal enhancement audio effect, and a style shift audio effect) are determined respectively according to user-related information corresponding to three users in the mobile terminal, and audio effect processing is performed on the fifth audio signal based on the three audio effect types.

Step 1064: Performing audio mixing processing on the sixth audio signal and a preset signal to obtain the third audio signal.

Optionally, when the foregoing embodiment is applied to a karaoke scene, the preset signal may be a preset accompaniment signal, and the third audio signal may be a karaoke sound signal obtained by mixing a vocal signal with the preset accompaniment signal. Audio mixing is a step in audio production, which combines sounds from various sources into a stereo audio track or a mono audio track. In this embodiment, sound sources are the sixth audio signal and the preset signal, for example, a human voice audio signal and a preset accompaniment signal. After the third audio signal is obtained, the embodiment may further include: playing the third audio signal inside the space of the mobile terminal and/or outside the space of the mobile terminal. Optionally, before the playing, other processing may also be performed on the third audio signal, and this is not limited in this application.

Optionally, the third audio signal may be played through a loudspeaker provided in the mobile terminal, and karaoke may be realized without another hardware device being added. For example, when the mobile terminal is a vehicle, the third audio signal is played through a loudspeaker built in the vehicle, or the third audio signal is played through a loudspeaker external to the vehicle, so that a karaoke experience inside or outside the vehicle may be achieved. Alternatively, the third audio signal is played simultaneously through a loudspeaker built in the vehicle and an external loudspeaker to achieve a karaoke experience both inside and outside the vehicle.

In some optional embodiments, there are many noise signals inside the mobile terminal (for example, a vehicle) that are irrelevant to a sound signal desired to be acquired, such as noise from air conditioner, wind noise, tire noise, and coughing and clapping of a passenger inside the vehicle. The presence of the noise signals may affect a proportion of vocal signals in the signal played by the loudspeaker, interfering with a karaoke experience of the user. Therefore, before audio effect processing is performed on the second audio signal or the fifth audio signal, the following may be further included: performing noise suppression processing on the plurality of second audio signals respectively, or performing noise suppression processing on the fifth audio signal.

In this embodiment, noise suppression for each second audio signal or the fifth audio signal may be implemented by using a noise suppression method. For example, a noise suppression network model is used to process the plurality of second audio signals or the fifth audio signal to output a plurality of second audio signals or a fifth audio signal on which noise suppression has been performed. The noise suppression network model is a deep neural network with any network structure. Before performing noise suppression, the noise suppression network model is trained with a training set including a large number of original sound signals, the original sound signals being corresponding to noise suppressed sound signals. A favorable noise suppression effect may be achieved by training the noise suppression network model.

In some optional embodiments, the first audio signals may be audio signals respectively corresponding to sounds emitted at different positions in the mobile terminal. Optionally, the acquiring of the first audio signals may include: acquiring the plurality first audio signals by acquiring sound signals at a plurality of positions in the space of the mobile terminal through a plurality of transducers.

In this embodiment, the transducer is a sound acquisition device, such as a MIC or a MIC array, that may implement sound acquisition. A plurality of positions (corresponding to a plurality of sound zones) may be included in the mobile terminal. For example, when the mobile terminal is a vehicle, there are four positions (four sound zones, including a driver sound zone, a front passenger sound zone, a rear left sound zone, and a rear right sound zone) in a space of the vehicle. Sound signals at a plurality of positions are acquired by providing a plurality of transducers. For example, one MIC array may be provided for each position. For another example, one MIC array may be provided for at least two positions. Alternatively, at least one MIC array may be provided for each position. In this embodiment, sound signals are acquired at a plurality of positions through a plurality of transducers to obtain first audio signals at the plurality of positions, allowing the sound signals at the plurality of positions in the mobile terminal to all participate in signal activity detection, thereby reducing a problem of signal missing due to incomplete sound pickup.

In some optional embodiments, the acquiring of the first audio signals may include: acquiring a plurality of seventh audio signals in the space of the mobile terminal.

In this embodiment, the seventh audio signals may be sound signals acquired from a plurality of positions (corresponding to a plurality of sound zones) in the space of the mobile terminal through a plurality of transducers. Optionally, each of the plurality of positions corresponds to one seventh audio signal. In this case, the seventh audio signals are mixed sound signals, and because at least the third audio signal played by the loudspeaker is also included in the mobile terminal, relatively great interference may occur to the seventh audio signals in the mobile terminal if interference suppression processing is not performed on the seventh audio signals.

Interference signals in the plurality of seventh audio signals are respectively eliminated to obtain the plurality of first audio signals.

In this embodiment, the third audio signal played by the loudspeaker is considered as a main interference signal in the mobile terminal. If the interference signals in the seventh audio signals are not eliminated, the first audio signals may include not only a first audio signal that needs to be acquired but also the third audio signal played synchronously by the loudspeaker, resulting in relatively large echo interference in the first audio signals. In this embodiment, echo interference in the first audio signal is avoided by eliminating the interference signals, thereby improving accuracy of audio acquisition. In addition, specifically elimination of the interference signals may include: performing interference signal elimination processing on the seventh audio signals respectively based on a reference (REF) signal to obtain the first audio signals, where the REF signal is determined based on the third audio signal. Optionally, the third audio signal is used as the REF signal. In this case, there is no need to acquire a REF signal through additional technical means; instead, the played third audio signal is acquired directly from a playback end of the loudspeaker as a REF signal.

In this embodiment, an estimation filter may be used to implement interference signal elimination processing by using a REF signal. The REF signal and the seventh audio signal are respectively input into the estimation filter, and a sound signal in the seventh audio signals that is the same as the REF signal is filtered out by the estimation filter, thereby implementing interference signal elimination. Optionally, the estimation filter is determined according to a path between the transducer and the loudspeaker. For example, a known signal may be played through the loudspeaker in advance, and the known signal acquired by the transducer and played by the loudspeaker is used to implement filter estimation to obtain the estimation filter. In this embodiment, a signal loss of the REF signal propagating from the loudspeaker to the transducer is simulated through the estimation filter, so that interference elimination can be more accurate, and preventing the obtained first audio signals from being affected by a sound signal played by the loudspeaker.

In an audio processing method provided in another exemplary embodiment of the present disclosure, which is applied to a karaoke scene in a vehicle, the mobile terminal is a vehicle including four sound zones. The method provided in this embodiment may include the following steps:

Among four in-vehicle MICs or MIC arrays, each MIC or MIC array corresponds to one sound zone in the vehicle, and acquires a sound signal emitted from the corresponding sound zone to obtain four seventh audio signals.

A played third audio signal is acquired directly from a playback end of a loudspeaker is used as a REF signal, interference signal elimination processing is performed on the four seventh audio signals respectively based on the REF signal, to obtain four first audio signals respectively based on the four seventh audio signals on which the interference elimination has been performed.

Separation processing is performed on the four first audio signals to obtain four fourth audio signals. Each of the fourth audio signals corresponds to one sound zone in the vehicle.

Voice activity detection (VAD) is performed on the four fourth audio signals respectively, and a fourth audio signal whose VAD result indicates presence of a vocal signal is determined as a second audio signal, to obtain at least one second audio signal (for example, three second audio signals).

Signal superposition is performed only on three second audio signals whose VAD results indicate presence of vocal signals to obtain a fifth audio signal. During karaoke mixing, only the second audio signals are involved in audio mixing, thereby maximizing output sound quality of an karaoke vocal while improving optimal sound quality of the karaoke vocal. After the fifth audio signal is obtained, noise suppression processing is performed on the fifth audio signal. Audio effect processing is performed on the fifth audio signal on which the noise suppression processing has been performed, to obtain a sixth audio signal.

Because an application scene in this embodiment is a karaoke scene, accompaniment audio in a corresponding karaoke application is also involved. Audio mixing processing is performed on the sixth audio signal and a preset accompaniment signal to obtain a third audio signal.

After the third audio signal is obtained, the third audio signal is played inside the vehicle through an audio playback device built in the vehicle and/or outside the vehicle through an audio playback device (for example, a loudspeaker) external to the vehicle according to a play mode set by a user instruction or according to a setting status of the audio playback device (for example, a loudspeaker) of the vehicle. For example, if the user instruction indicates internal karaoke, the third audio signal is correspondingly played inside the vehicle through a loudspeaker built in the vehicle to implement the internal karaoke. For another example, if the user instruction indicates internal and external karaoke, the third audio signal is correspondingly played both inside and outside the vehicle through a loudspeaker built in the vehicle and a loudspeaker external to the vehicle to implement the internal and external karaoke.

Any one of the audio processing methods provided in the embodiments of the present disclosure may be performed by any suitable electronic device with a data processing ability, including but not limited to: a terminal/a mobile terminal device, a server, or the like. Alternatively, any one of the audio processing methods provided in the embodiments of the present disclosure may be performed by a processor. For example, the processor performs, by calling a corresponding instruction stored in a memory, any one of the audio processing methods mentioned in the embodiments of the present disclosure. This is not repeated below.

The method steps provided in the embodiments of the present disclosure may be arbitrarily combined/added/deleted as long as such modification is feasible.

### Exemplary Apparatus

FIG. 6 is a schematic diagram illustrating a structure of an audio processing apparatus according to an exemplary embodiment of the present disclosure. As shown in FIG. 6, the apparatus provided in this embodiment includes:

an audio acquisition module 61, configured to acquire a plurality of first audio signals in a space of a mobile terminal, where Optionally, naming of the audio acquisition module is only exemplary, and the module may also be referred to as an audio acquisition module, an audio pickup module, or the like;

an audio screening module 62, configured to determine, based on the plurality of first audio signals, a second audio signal corresponding to at least one position in the space of the mobile terminal; and

a signal processing module 63, configured to perform audio mixing based on the at least one second audio signal to obtain a third audio signal.

According to the audio processing apparatus provided in the foregoing embodiment of the present disclosure, a second audio signal corresponding to at least one position in a space of a mobile terminal is determined from a plurality of first audio signals, achieving recognition of a second audio signal corresponding to at least one position at which a voice is emitted. Audio mixing is performed only on at least one second audio signal to obtain a third audio signal, and a signal corresponding to a position at which no voice is emitted does not participate in the audio mixing, thereby improving sound quality of the third audio signal.

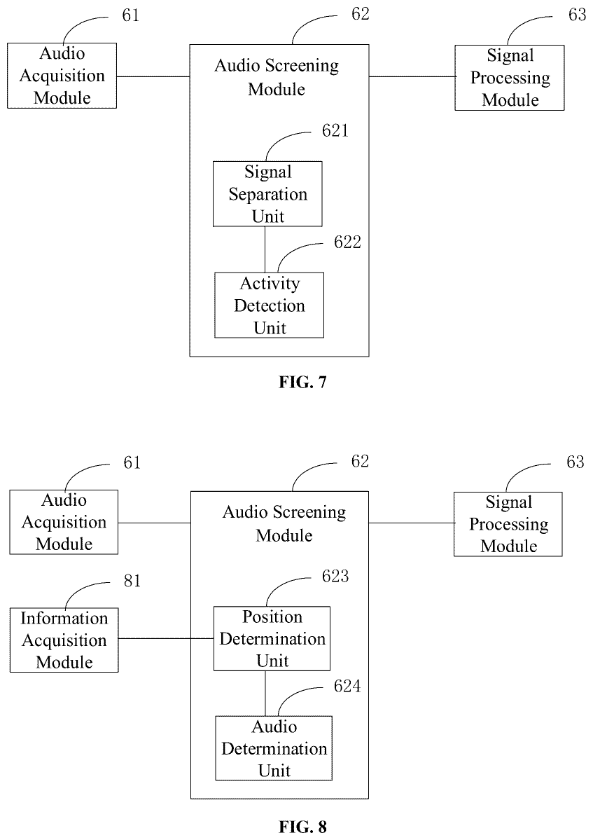

FIG. 7 is a schematic diagram illustrating a structure of an audio processing apparatus according to another exemplary embodiment of the present disclosure. As shown in FIG. 7, the audio screening module 62 in the apparatus provided in this embodiment includes:

a signal separation unit 621, configured to perform separation processing on the plurality of first audio signals to obtain a plurality of fourth audio signals; and

an activity detection unit 622, configured to determine the at least one second audio signal based on the plurality of fourth audio signals, for example, a VAD unit.

Optionally, the signal separation unit 621 is specifically configured to input the plurality of first audio signals into a first neural network model, and output the plurality of fourth audio signals respectively through a plurality of output channels of the first neural network model. Each of the output channels correspondingly outputs one of the fourth audio signals.

Optionally, the activity detection unit 622 is specifically configured to perform VAD on the plurality of fourth audio signals respectively to determine the at least one second audio signal.

The signal separation unit 621 and the activity detection unit 622 in this embodiment are physically implemented as one or more units, which may be implemented in hardware and/or software to determine the second audio signal according to the activity detection.

FIG. 8 is a schematic diagram illustrating a structure of an audio processing apparatus according to still another exemplary embodiment of the present disclosure. A plurality of first audio signals correspond to a plurality of positions in the space of the mobile terminal. As shown in FIG. 8, the audio screening module 62 in the apparatus provided in this embodiment includes:

a position determination unit 623, configured to determine, according to user feature information, at least one voice emission position from the plurality of positions corresponding to the plurality of first audio signals; and

an audio determination unit 624, configured to determine the at least one second audio signal according to the at least one voice emission position.

In some optional embodiments, the user feature information includes multimodal information of a user. The position determination unit 623 is specifically configured to perform recognition on the plurality of positions according to the multimodal information to obtain an recognition result; and determine, according to the recognition result, the at least one voice emission position from the plurality of positions corresponding to the plurality of first audio signals. Optionally, multimodal information includes image information or video information. The apparatus provided in this embodiment further includes:

an information acquisition module 81, configured to acquire image information or video information at a plurality of positions in the space of the mobile terminal through at least one sensor.

The information acquisition module 81, the position determination unit 623, and the audio determination unit 624 in this embodiment are physically implemented as one or more units, which may be implemented in hardware and/or software to determine the second audio signal according to the voice emission position.

FIG. 9 is a schematic diagram illustrating a structure of an audio processing apparatus according to yet another exemplary embodiment of the present disclosure. As shown in FIG. 9, the signal processing module 63 in the apparatus provided in this embodiment includes:

a signal superposition unit 631, configured to perform signal superposition on the at least one second audio signal to obtain a fifth audio signal; and

an audio mixing processing unit 632, configured to perform audio mixing processing on the fifth audio signal and a preset signal to obtain the third audio signal.

Optionally, the signal processing module 63 may further include:

an audio effect processing unit 633, configured to perform audio effect processing on the fifth audio signal to obtain a sixth audio signal.

The audio mixing processing unit 632 is specifically configured to perform audio mixing processing on the sixth audio signal and the preset signal to obtain the third audio signal.

In some optional embodiments, the audio acquisition module 61 is specifically configured to acquire sound signals at a plurality of positions in the space of the mobile terminal through a plurality of transducers to obtain the plurality of first audio signals.

The signal superposition unit 631, the audio effect processing unit 633, and the audio mixing processing unit 632 in this embodiment are physically implemented as one or more units, which may be implemented in hardware and/or software to determine the third audio signal.

As shown in FIG. 9, the audio acquisition module 61 may include:

an audio acquisition unit 611, configured to acquire a plurality of seventh audio signals in the space of the mobile terminal; and

an interference elimination unit 612, configured to respectively eliminate interference signals in the plurality of seventh audio signals to obtain the plurality of first audio signals.

The interference elimination unit 612 is specifically configured to perform interference signal elimination processing on the seventh audio signals respectively based on a REF signal to obtain the first audio signals. The REF signal is determined based on the third audio signal.

The audio acquisition unit 611 and the interference elimination unit 612 in this embodiment are physically implemented as one or more units, which may be implemented in hardware and/or software to obtain the plurality of first audio signals.

In the embodiment shown in FIG. 9, the apparatus provided in this embodiment of the present disclosure may further include: an audio playback module 91, configured to play the third audio signal inside the space of the mobile terminal through an audio playback device built in the mobile terminal, and/or outside the space of the mobile terminal through an audio playback device external to the mobile terminal.

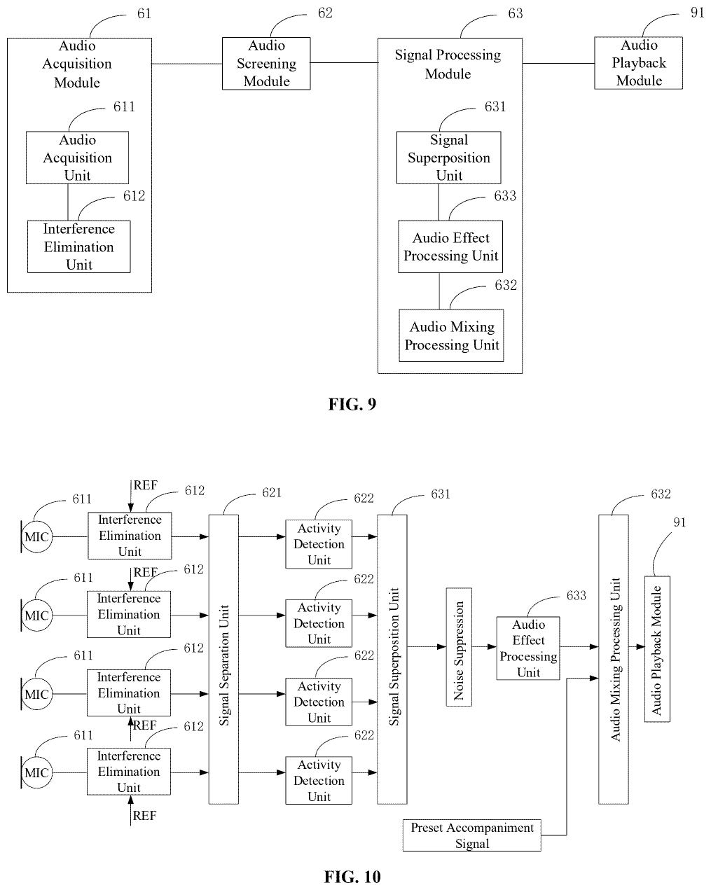

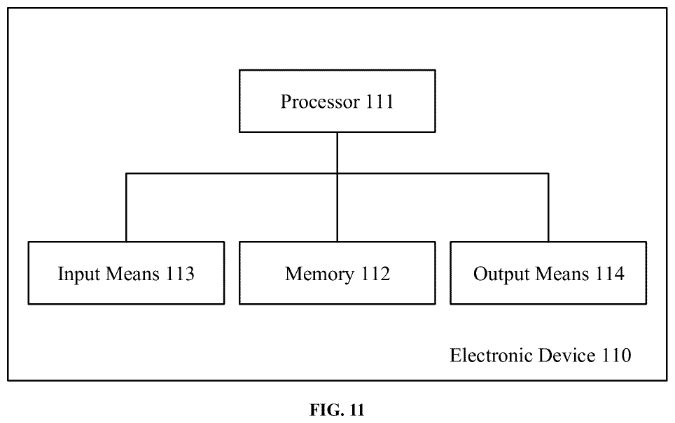

FIG. 10 is a schematic diagram illustrating a structure of an audio processing apparatus according to still yet another exemplary embodiment of the present disclosure. As shown in FIG. 10, this embodiment is applied to a MIC-free karaoke scene in a vehicle. The mobile terminal is a vehicle including four sound zones. In the apparatus provided in this embodiment:

An audio acquisition unit 611 includes four microphones (MIC). Each of the MICs corresponds to one sound zone in the vehicle, and acquires a sound signal emitted from the corresponding sound zone to obtain four seventh audio signals.

An interference elimination unit 612 separately corresponds to the four seventh audio signals, and is configured to perform interference signal elimination processing on the four seventh audio signals respectively based on a reference (REF) signal, to obtain four first audio signals respectively based on the four seventh audio signals on which interference elimination has been performed. The REF signal is determined based on a third audio signal.

A signal separation unit 621 performs separation processing on the four first audio signals to obtain four fourth audio signals. Each of the fourth audio signals corresponds to one sound zone in the vehicle.

An activity detection unit 622 performs VAD on the four fourth audio signals, and determines a fourth audio signal whose VAD result indicates presence of a vocal signal as a second audio signal, to obtain three second audio signals.

A signal superposition unit 631 performs signal superposition only on the three second audio signals whose VAD results indicate presence of vocal signals to obtain a fifth audio signal. During karaoke mixing, only the second audio signals are involved in audio mixing, thereby maximizing output sound quality of an karaoke vocal while improving optimal sound quality of the karaoke vocal. After the fifth audio signal is obtained, noise suppression processing is performed on the fifth audio signal.

An audio effect processing unit 633 performs audio effect processing on the fifth audio signal on which the noise suppression processing has been performed to obtain a sixth audio signal.

Because an application scene in this embodiment is a karaoke scene, accompaniment audio in a corresponding karaoke application is also included. An audio mixing processing unit 632 performs audio mixing processing on the sixth audio signal and a preset accompaniment signal to obtain a third audio signal.

After obtaining the third audio signal, an audio playback module 91 plays the third audio signal inside the vehicle through an audio playback device built in the vehicle and/or outside the vehicle through an audio playback device (for example, a loudspeaker) external to the vehicle according to a play mode set by a user instruction or according to a setting status of the audio playback device (for example, a loudspeaker) of the vehicle. For example, if the user instruction indicates internal karaoke, the third audio signal is correspondingly played inside the vehicle through a loudspeaker built in the vehicle to implement the internal karaoke. For another example, if the user instruction indicates internal and external karaoke, the third audio signal is correspondingly played both inside and outside the vehicle through a loudspeaker built in the vehicle and a loudspeaker external to the vehicle to implement the internal and external karaoke.

The third audio signal obtained in the foregoing embodiment is further input into the interference elimination unit 612 as the REF signal, to implement interference signal elimination processing on the seventh audio signal.

For beneficial technical effects corresponding to the exemplary embodiment of the apparatus in the present disclosure, refer to the corresponding beneficial technical effects of the exemplary method section described above, which are not repeated herein.

### Exemplary Electronic Device

FIG. 11 is a structural diagram of an electronic device according to an embodiment of the present disclosure. The electronic device includes at least one processor 111 and a memory 112.

The processor 111 may be a central processing unit (CPU) or another form of processing unit having a data processing ability and/or an instruction execution ability, and may control another component in the electronic device 110 to perform a desired function.

The memory 112 may include one or more computer program products. The computer program product may include various forms of computer readable storage media, such as a volatile memory and/or a non-volatile memory. The volatile memory may include, for example, a random access memory (RAM) and/or a cache. The non-volatile memory may include, for example, a read-only memory (ROM), a hard disk, or a flash memory. The computer readable storage medium may store one or more computer program instructions. The processor 110 may run the one or more computer program instructions to implement the audio processing method and/or other desired functions in the foregoing embodiments of the present disclosure.

In an example, the electronic device 110 may further include: an input means 113 and an output means 114. The components are interconnected through a bus system and/or other forms of connection mechanisms (not shown).

The input means 113 may further include, for example, a keyboard or a mouse.

The output means 114 may output various information to the outside, and may include, for example, a display, a loudspeaker, a printer, and a communication network and a remote output means connected thereto.

Certainly, for simplicity, only some components in the electronic device 110 that are related to the present disclosure are shown in FIG. 11, and components such as a bus and an input/output interface are omitted. Besides, the electronic device 110 may further include any other appropriate components depending on specific applications.

### Exemplary Computer Program Product and Computer Readable Storage Medium

In addition to the foregoing method and device, the embodiments of the present disclosure may also provide a computer program product including computer program instructions that, when run by a processor, cause the processor to perform the steps of the audio processing method according to the embodiments of the present disclosure that is described in the “exemplary method” section.

The computer program product may be program code, written with one or any combination of a plurality of programming languages, that is configured to perform the operations in the embodiments of the present disclosure. The programming languages include an object-oriented programming language such as Java or C++, and further include a conventional procedural programming language such as a “C” language or a similar programming language. The program code may be entirely or partially executed on a user computing device, executed as an independent software package, partially executed on the user computing device and partially executed on a remote computing device, or entirely executed on the remote computing device or a server.

In addition, the embodiments of the present disclosure may further relate to a computer readable storage medium, on which computer program instructions are stored. The computer program instructions, when run by a processor, cause the processor to perform the steps of the audio processing method according to the embodiments of the present disclosure that is described in the “exemplary method” section.

The computer readable storage medium may be one readable medium or any combination of a plurality of readable media. The readable medium may be a readable signal medium or a readable storage medium. The readable storage medium includes, for example, but is not limited to electrical, magnetic, optical, electromagnetic, infrared, or semiconductor systems, apparatuses, or devices, or any combination of the above. More specific examples (a non-exhaustive list) of the readable storage medium include: an electrical connection with one or more conducting wires, a portable disk, a hard disk, a RAM, a ROM, an EPROM or a flash memory, an optical fiber, a portable compact disk ROM (CD-ROM), an optical storage device, a magnetic storage device, or any suitable combination of the above.

Basic principles of the present disclosure are described above in combination with specific embodiments. However, the advantages, superiorities, effects, and the like mentioned in the present disclosure are merely examples rather than limitations, and it should not be considered that these advantages, superiorities, effects, and the like are necessary for each of the embodiment of the present disclosure. In addition, specific details disclosed above are merely for examples and for ease of understanding, rather than limitations. The details described above do not limit that the present disclosure must be implemented by using the foregoing specific details.

A person skilled in the art may make various modifications and variations to the present disclosure without departing from the spirit and scope of this application. The present disclosure is intended to cover these modifications and variations provided that they fall within the scope of protection defined by the claims of the present disclosure or equivalents thereof.

1. An audio processing method, comprising:
acquiring a plurality of first audio signals in a space of a mobile terminal;
determining, based on the plurality of first audio signals, a second audio signal corresponding to at least one position in the space of the mobile terminal; and
performing audio mixing based on at least one second audio signal to obtain a third audio signal.

2. The method according to claim 1, wherein the determining, based on the plurality of first audio signals, a second audio signal corresponding to at least one position in the space of the mobile terminal comprises:
performing separation processing on the plurality of first audio signals to obtain a plurality of fourth audio signals; and
determining the at least one second audio signal based on the plurality of fourth audio signals.

3. The method according to claim 2, wherein the performing separation processing on the plurality of first audio signals to obtain a plurality of fourth audio signals comprises:
inputting the plurality of first audio signals into a first neural network model, and outputting the plurality of fourth audio signals respectively through a plurality of output channels of the first neural network model.

4. The method according to claim 2, wherein the determining the at least one second audio signal based on the plurality of fourth audio signals comprises:
performing voice activity detection (VAD) on the plurality of fourth audio signals respectively to determine the at least one second audio signal.

5. The method according to claim 1, wherein the plurality of first audio signals correspond to a plurality of positions in the space of the mobile terminal; and
the determining, based on the plurality of first audio signals, a second audio signal corresponding to at least one position in the space of the mobile terminal comprises:
determining, according to user feature information, at least one voice emission position from the plurality of positions corresponding to the plurality of first audio signals; and
determining the at least one second audio signal according to the at least one voice emission position.

6. The method according to claim 5, wherein the user feature information comprises multimodal information of a user; and
the determining, according to user feature information, at least one voice emission position from the plurality of positions corresponding to the plurality of first audio signals comprises:
performing recognition on the plurality of positions corresponding to the plurality of first audio signals according to the multimodal information to obtain an recognition result; and
determining, according to the recognition result, the at least one voice emission position from the plurality of positions corresponding to the plurality of first audio signals.

7. The method according to claim 6, wherein the multimodal information comprises image information or video information.

8. The method according to claim 1, wherein the performing audio mixing based on the at least one second audio signal to obtain a third audio signal comprises:
performing signal superposition on the at least one second audio signal to obtain a fifth audio signal; and
performing audio mixing processing on the fifth audio signal and a preset signal to obtain the third audio signal.

9. The method according to claim 8, wherein before the performing audio mixing processing on the fifth audio signal and a preset signal to obtain the third audio signal, the method further comprises:
performing audio effect processing on the fifth audio signal to obtain a sixth audio signal; and
the performing audio mixing processing on the fifth audio signal and a preset signal to obtain the third audio signal comprises:
performing audio mixing processing on the sixth audio signal and the preset signal to obtain the third audio signal.

10. The method according to claim 8, wherein the acquiring a plurality of first audio signals in a space of a mobile terminal comprises:
acquiring sound signals at a plurality of positions in the space of the mobile terminal through a plurality of transducers to obtain the plurality of first audio signals.

11. The method according to claim 8, wherein the acquiring a plurality of first audio signals in a space of a mobile terminal comprises:
acquiring a plurality of seventh audio signals in the space of the mobile terminal; and
eliminating interference signals in the plurality of seventh audio signals, respectively, to obtain the plurality of first audio signals.

12. The method according to claim 1, further comprising:
playing the third audio signal inside the space of the mobile terminal and/or outside the space of the mobile terminal.

13. A non-transitory computer readable storage medium, on which a computer program is stored, wherein the computer program, when executed by a processor, causes the processor to implement the audio processing method according to claim 1.

14. The non-transitory computer readable storage medium according to claim 13, the determining, based on the plurality of first audio signals, a second audio signal corresponding to at least one position in the space of the mobile terminal comprises:
performing separation processing on the plurality of first audio signals to obtain a plurality of fourth audio signals; and
determining the at least one second audio signal based on the plurality of fourth audio signals.

15. The non-transitory computer readable storage medium according to claim 14, wherein the performing separation processing on the plurality of first audio signals to obtain a plurality of fourth audio signals comprises:
inputting the plurality of first audio signals into a first neural network model, and outputting the plurality of fourth audio signals respectively through a plurality of output channels of the first neural network model.

16. The non-transitory computer readable storage medium according to claim 14, wherein the determining the at least one second audio signal based on the plurality of fourth audio signals comprises:
performing voice activity detection (VAD) on the plurality of fourth audio signals respectively to determine the at least one second audio signal.

17. The non-transitory computer readable storage medium according to claim 13, wherein the plurality of first audio signals correspond to a plurality of positions in the space of the mobile terminal; and
the determining, based on the plurality of first audio signals, a second audio signal corresponding to at least one position in the space of the mobile terminal comprises:
determining, according to user feature information, at least one voice emission position from the plurality of positions corresponding to the plurality of first audio signals; and
determining the at least one second audio signal according to the at least one voice emission position.

18. The non-transitory computer readable storage medium according to claim 17, wherein the user feature information comprises multimodal information of a user; and
the determining, according to user feature information, at least one voice emission position from the plurality of positions corresponding to the plurality of first audio signals comprises:
performing recognition on the plurality of positions corresponding to the plurality of first audio signals according to the multimodal information to obtain an recognition result; and
determining, according to the recognition result, the at least one voice emission position from the plurality of positions corresponding to the plurality of first audio signals.

19. The non-transitory computer readable storage medium according to claim 18, wherein the multimodal information comprises image information or video information.

20. The non-transitory computer readable storage medium according to claim 13, wherein the performing audio mixing based on the at least one second audio signal to obtain a third audio signal comprises:
performing signal superposition on the at least one second audio signal to obtain a fifth audio signal; and
performing audio mixing processing on the fifth audio signal and a preset signal to obtain the third audio signal.
